(19) United States
(12) Patent Application Publication
(10) Pub. No.: US 2013/0034997 A1
(43) Pub. Date: Feb. 7, 2013

(54) ELECTRICAL CONNECTOR

(71) Applicant: CHIH-LIN YANG, New Taipei City (TW)

(72) Inventor: CHIH-LIN YANG, New Taipei City (TW)

(73) Assignee: Cheng Uei Precision Industry Co., LTD., New Taipei City (TW)

(21) Appl. No.: 13/198,707

(22) Filed: Aug. 4, 2011

(51) Int. Cl. H01R 13/46; H01R 4/48

(52) U.S. Cl. 439/625

(57) ABSTRACT

An electrical connector includes an insulating housing, a clipping contact having a base plate with a window, a contact section, an elastic section and a resisting tail stretched in the window, and a connecting contact having a connecting arm inserted in the window and electrically abutting under the resisting tail. The contacts are assembled in the insulating housing with the base plate being movable in the insulating housing. An operating element is assembled to a top of the insulating housing and rotatable between an open position where a front end thereof presses the contact section downward to drive the base plate to move downward so as to realize an interval between the connecting arm and a bottom side of the window for insertion of a cable, and a closed position where the contact section is set free to rebound upward for clipping the cable in the interval.

### BACKGROUND OF THE INVENTION

1. Field of the Invention

The present invention generally relates to an electrical connector, and more particularly to an electrical connector capable of connecting with a cable.

2. The Related Art

A conventional electrical connector adapted for connecting a cable with a printed circuit board includes an insulating housing, an assistant terminal and a conductive terminal which are assembled in the insulating housing and electrically connect with each other. The conductive terminal is adapted to be soldered with the printed circuit board. The assistant terminal has a connecting portion with a wedging hole being opened therein. When the cable need be connected to the electrical connector, a conductive core of one end of the cable is inserted into the wedging hole of the connecting portion of the assistant terminal. Then the conductive core is further soldered together with the connecting portion of the assistant terminal. So, an electrical connection is realized between the cable and the printed circuit board by means of the electrical connector. However, the foregoing connection operation between the cable and the electrical connector not only is complex, but also wastes working time.

### SUMMARY OF THE INVENTION

An object of the present invention is to provide an electrical connector for connecting with a cable. The electrical connector includes a clipping contact which has a base plate with a window therein, a contact section bent downward from a top end of the base plate, and an arc elastic section connected with a free end of the contact section with a mouth thereof facing the base plate. A free end of the elastic section extends towards the window of the base plate to form a resisting plate of which a substantial middle of a free edge further projects to form a resisting tail stretching in the window apart from a top side of the window and near a bottom side of the window. A connecting contact has a base strip of which a substantial middle of a rear edge bends downward and then slantwise extends rearward to form a connecting arm inserted rearward in the window of the clipping contact and abutting under the resisting tail and the resisting plate to realize an electrical connection with the clipping contact. The connecting arm is further against the bottom side of the window. An insulating housing defines an inserting trench penetrating through a front thereof. The clipping contact together with the connecting contact is assembled in the insulating housing with the base plate being movable in the insulating housing and the base strip being hanged over the inserting trench. An operating element has an operating board of which a front end is designed as a pressing portion. The operating element is assembled to a top of the insulating housing and rotatable between an open position where the pressing portion presses the contact section downward to drive the base plate to move downward so as to realize an interval between the connecting arm and the bottom side of the window for the convenience of one end of the cable passing through the inserting trench to be inserted therein, and a closed position where the contact section is set free from the pressing portion to rebound upward by virtue of the restoring resilience of the elastic section so as to clip the one end of the cable between the connecting arm and the bottom side of the window.

As described above, the electrical connector of the present invention utilizes the cooperation of the clipping contact, the connecting contact and the operating element to conveniently realize assembly and disassembly of the cable in the electrical connector. So, a simple connection operation is realized between the cable and the electrical connector.

### BRIEF DESCRIPTION OF THE DRAWINGS

The present invention will be apparent to those skilled in the art by reading the following description, with reference to the attached drawings, in which:

FIG. 1 is an assembled perspective view of an electrical connector in accordance with an embodiment of the present invention;

FIG. 2 is an exploded perspective view of the electrical connector of FIG. 1;

FIG. 3 is a perspective view of an upper housing of the electrical connector of FIG. 1;

FIG. 4 is a sectional perspective view showing that the upper housing and a lower housing are coupled to each other according to the electrical connector of FIG. 1;

FIG. 5 is a perspective view of a clipping contact of the electrical connector of FIG. 2;

FIG. 6 is a perspective view of a connecting contact of the electrical connector of FIG. 2;

FIG. 7 is a sectional perspective view of the electrical connector of FIG. 1; and

FIG. 8 is a sectional perspective view showing that a cable is assembled in the electrical connector of FIG. 1.

### DETAILED DESCRIPTION OF THE PREFERRED EMBODIMENT

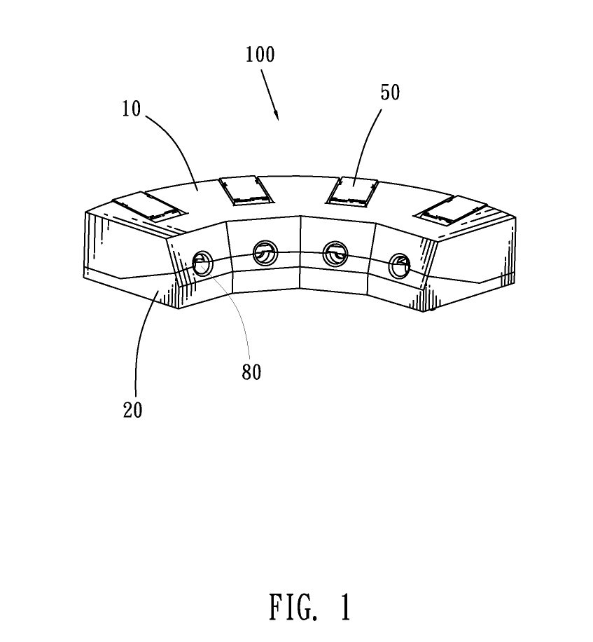

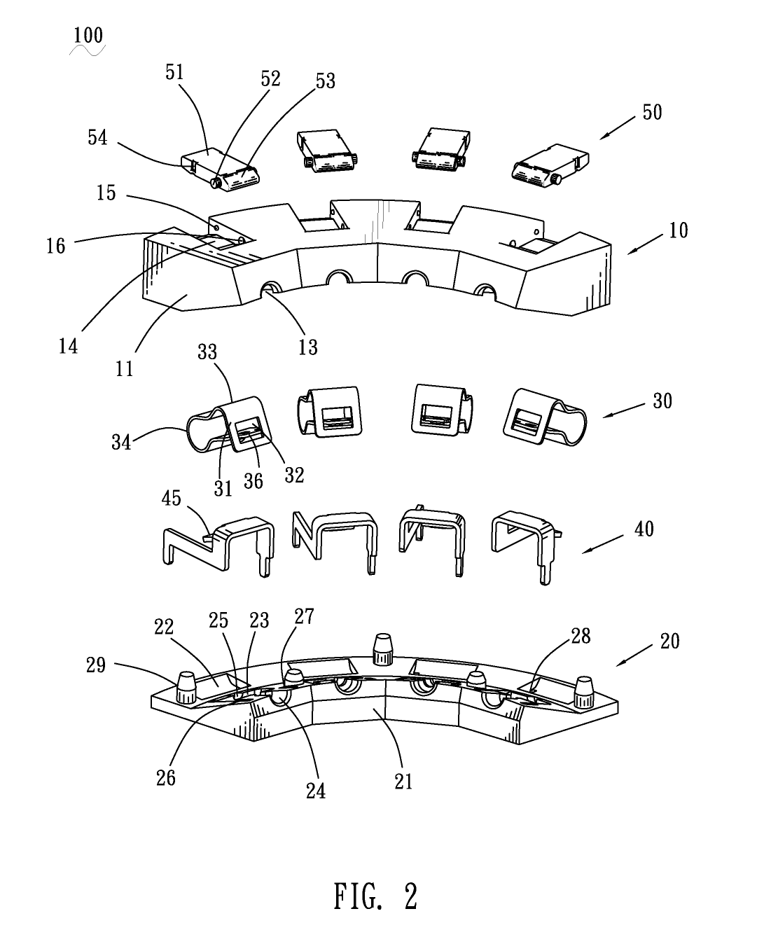

With reference to FIG. 1 and FIG. 2, an electrical connector 100 in accordance with an embodiment of the present invention is shown. The electrical connector 100 is adapted for connecting a cable 60 (shown in FIG. 8) with a printed circuit board (not shown). The electrical connector 100 includes an insulating housing composed of an upper housing 10 and a lower housing 20 matched with each other, a plurality of clipping contacts 30, a plurality of connecting contacts 40 and a plurality of operating elements 50 assembled in the insulating housing respectively. In this embodiment, there are equal quantity of the clipping contacts 30, the connecting contacts 40 and the operating elements 50.

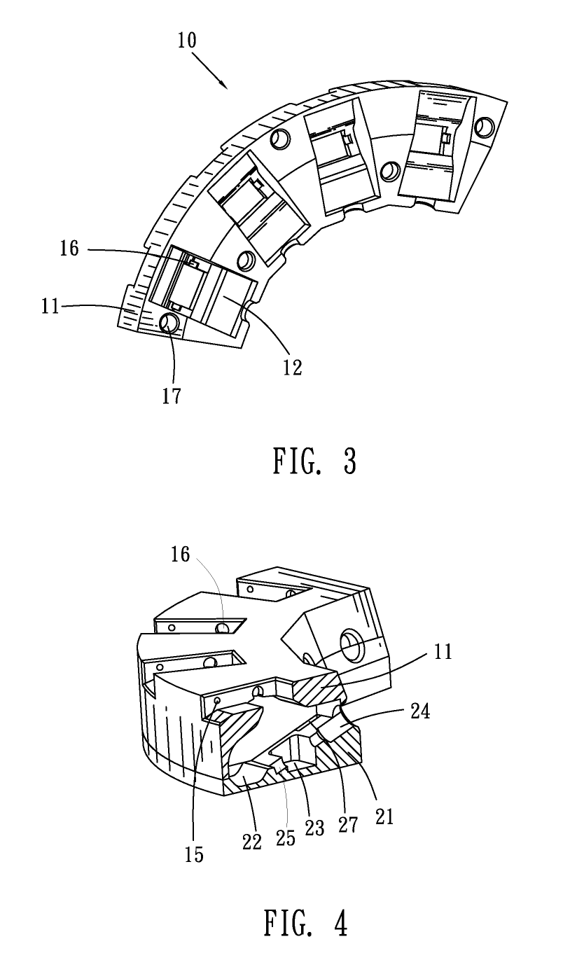

Referring to FIG. 2 and FIG. 3, the upper housing 10 has an arc base body 11 of which a bottom side defines a plurality of receiving cavities 12 arranged at regular intervals along an arc direction of the base body 11. A bottom of a front side of each receiving cavity 12 is concaved upward to form a semicircle upper inserting trench 13 penetrating through a front of the base body 11. A top side of the base body 11 defines a plurality of accommodating cavities 14 arranged over the receiving cavities 12 one-on-one and each having a front thereof connected with a substantial middle of the corresponding receiving cavity 12. The accommodating cavity 14 further penetrates through a rear of the base body 11, and has two opposite sides thereof provided with a pair of locking bumps 15 facing each other at rear thereof and a pair of pivot holes 16 facing each other at front thereof. The bottom side of the base body 11 further defines a plurality of fastening holes 17 arranged alternately at regular intervals along the arc direction thereof.

Referring to FIG. 2 and FIG. 4, the lower housing 20 has an arc base pedestal 21 matched with the base body 11 of the upper housing 10. A substantial middle of a top side of the base pedestal 21 defines a plurality of receiving fillisters 23 arranged at regular intervals along an arc direction of the base pedestal 21. The top side of the base pedestal 21 further defines a plurality of receiving grooves 22 corresponding to and arranged behind the receiving fillisters 23 respectively, a plurality of semicircle lower inserting trenches 24 penetrating through a front of the base pedestal 21 and each having a rear end thereof connected with a substantial middle of a front of one receiving fillister 23, and a plurality of fastening trenches 25 each connected with a substantial middle of a rear of one receiving fillister 23 and coaxial with the corresponding lower inserting trench 24. Two opposite sides of each lower inserting trench 24 are respectively provided with a first inserting slot 27 vertically penetrating through the base pedestal 21, and a fastening slot 26 penetrating through the top side of the base pedestal 21. One side of a bottom side of each receiving groove 22 defines a second inserting slot 28 aligned with the corresponding fastening slot 26 and vertically penetrating through the base pedestal 21. The top side of the base pedestal 21 protrudes upward to form a plurality of fastening pillars 29 arranged alternately at regular intervals along the arc direction thereof and in accordance with the fastening holes 17 of the upper housing 10.

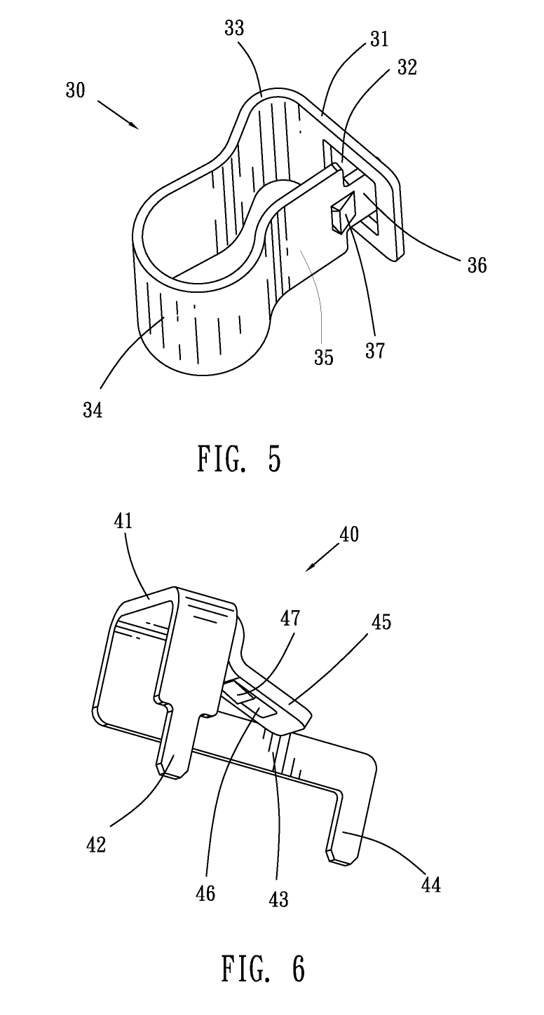

Referring to FIG. 2 and FIG. 5, the clipping contact 30 has a base plate 31 with a window 32 being opened in a substantial middle thereof, an arched contact section 33 bent downward from a top edge of the base plate 31, and an arc elastic section 34 connected with a free end of the contact section 33 with a mouth thereof facing the base plate 31. A free end of the elastic section 34 is bent upward and then extends towards the window 32 of the base plate 31 to form a resisting plate 35 of which a middle of a free edge further projects to form a resisting tail 36 elastically stretching in the window 32 apart from a top side of the window 32 and near a bottom side of the window 32. A bottom of the resisting plate 35 protrudes downward to form a buckling block 37.

Referring to FIG. 2 and FIG. 6, the connecting contact 40 has a base strip 41 of which two opposite ends extend downward to form a first soldering tail 42 and an L-shaped fastening arm 43 seen from a lateral view. A free end of the fastening arm 43 extends downward to form a second soldering tail 44. A middle of a rear edge of the base strip 41 bends downward and then slantwise extends to form a connecting arm 45 located at the same side of the base strip 41 as the second soldering tail 44. A buckling hole 46 is opened in the connecting arm 45, and a securing projection 47 protruded downward at a bottom side of the connecting arm 45 and adjacent to the buckling hole 46.

Referring to FIG. 2 again, the operating element 50 has a rectangular operating board 51 of which a front end is designed as a pressing portion 53. Two opposite sides of a front of the operating board 51 oppositely protrude sideward to form a pair of pivot posts 52, and two opposite sides of a rear of the operating board 51 define a pair of locking grooves 54.

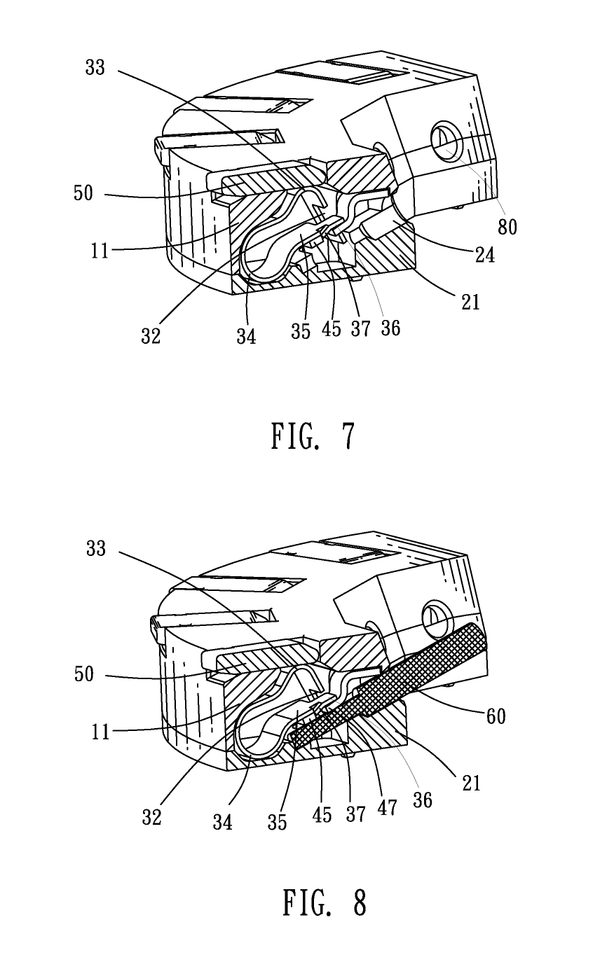

Referring to FIGS. 1-7, in assembly, the connecting arm 45 of the connecting contact 40 is inserted into the window 32 of the corresponding clipping contact 30 and clipped between the resisting tail 36 and the bottom side of the window 32, wherein the connecting arm 45 is secured together with and abuts under the resisting tail 36 and the resisting plate 35 by means of the buckling block 37 being buckled in the buckling hole 46. Then, the clipping contact 30 together with the connecting contact 40 are assembled to the lower housing 20 by means of the fastening arm 43 being secured in the fastening slot 26, the first soldering tail 42 and the second soldering tail 44 being inserted in the first inserting slot 27 and the second inserting slot 28 respectively and further projecting beyond a bottom of the base pedestal 21 for being soldered with the printed circuit board. The base strip 41 is hanged over the lower inserting trench 24 of the base pedestal 21, and the base plate 31 of the clipping contact 30 can be movably received in the receiving fillister 23. The upper housing 10 is coupled onto the lower housing 20 by virtue of the fastening pillars 29 being inserted in the fastening holes 17 respectively, with the elastic section 34 of the clipping contact 30 being restrained in the receiving groove 22 and a rear of the corresponding receiving cavity 12, the base strip 41 being received in a front of the receiving cavity 12, and the contact section 33 passing through the substantial middle of the receiving cavity 12 to stretch into the corresponding accommodating cavity 14. The upper inserting trenches 13 are matched with the lower inserting trenches 24 one-on-one to form a plurality of inserting trenches 80. The operating elements 50 are rotatably coupled in the accommodating cavities 14 of the upper housing 10 respectively by means of the pivot posts 52 being inserted in the corresponding pivot holes 16. The operating element 50 is rotatable between a closed position where the contact section 33 abuts against a bottom of the operating board 51 and the locking bumps 15 are buckled in the corresponding locking grooves 54, and an open position where the pressing portion 53 presses the contact section 33 downward.

Referring to FIG. 8, in use, the operating board 51 of the operating element 50 is raised upward so that the pressing portion 53 can press the contact section 33 of the corresponding clipping contact 30 downward. In the process of the operating element 50 being opened, the base plate 31 moves downward under the drive of the contact section 33 pressed by the pressing portion 53 to realize an interval between the connecting arm 45 of the connecting contact 40 and the bottom side of the window 32 of the clipping contact 30, wherein the interval is formed in alignment with the inserting trench 80 and the fastening trench 25 for the convenience of insertion of the cable 60. In detail, one end of the cable 60 successively passes through the inserting trench 80 and the interval to be fastened in the fastening trench 25. Then, press the operating board 51 back to make the operating element 50 re-coupled in the accommodating cavity 14 of the upper housing 10 by means of the locking bumps 15 being buckled in the locking grooves 54 again. In the process of the operating element 50 being closed, the contact section 33 is set free from the pressing portion 53 to rebound upward by virtue of the restoring resilience of the elastic section 34 so as to firmly and electrically clip the one end of the cable 60 between the connecting arm 45 and the bottom side of the window 32. The securing projection 47 of the connecting arm 45 abuts against a periphery outside of the one end of the cable 60 to further secure the one end of the cable 60 in the electrical connector 100.

As described above, the electrical connector 100 of the present invention utilizes the cooperation of the clipping contact 30, the connecting contact 40 and the operating element 50 to conveniently realize assembly and disassembly of the cable 60 in the electrical connector 100. So a simple connection operation is realized between the cable 60 and the electrical connector 100.

What is claimed is:

1. An electrical connector for connecting with a cable, comprising:
a clipping contact having a base plate with a window therein, a contact section bent downward from a top end of the base plate, and an arc elastic section connected with a free end of the contact section with a mouth thereof facing the base plate, a free end of the elastic section extending towards the window of the base plate to form a resisting plate of which a substantial middle of a free edge further projects to form a resisting tail stretching in the window apart from a top side of the window and near a bottom side of the window;
a connecting contact having a base strip of which a substantial middle of a rear edge bends downward and then slantwise extends rearward to form a connecting arm inserted rearward in the window of the clipping contact and abutting under the resisting tail and the resisting plate to realize an electrical connection with the clipping contact, the connecting arm being further against the bottom side of the window;
an insulating housing defining an inserting trench penetrating through a front thereof, the clipping contact together with the connecting contact being assembled in the insulating housing with the base plate being movable in the insulating housing, and the base strip being hanged over the inserting trench; and
an operating element having an operating board of which a front end is designed as a pressing portion, the operating element being assembled to a top of the insulating housing and rotatable between an open position where the pressing portion presses the contact section downward to drive the base plate to move downward so as to realize an interval between the connecting arm and the bottom side of the window for the convenience of one end of the cable passing through the inserting trench to be inserted therein, and a closed position where the contact section is set free from the pressing portion to rebound upward by virtue of the restoring resilience of the elastic section so as to clip the one end of the cable between the connecting arm and the bottom side of the window.

2. The electrical connector as claimed in claim 1, wherein a bottom of the resisting plate of the clipping contact protrudes downward to form a buckling block, a buckling hole is opened in the connecting arm of the connecting contact for buckling the buckling block therein to secure the connecting arm together with the resisting tail and the resisting plate.

3. The electrical connector as claimed in claim 1, wherein one end of the base strip of the connecting contact extends downward to form a first soldering tail, the other end of the base strip is bent downward and then extends rearward to form a fastening arm of which a free end extends downward to form a second soldering tail, the fastening arm is fastened in the insulating housing, the first soldering tail and the second soldering tail are inserted downward in the insulating housing and further project out of a bottom of the insulating housing.

4. The electrical connector as claimed in claim 1, wherein a bottom of the connecting arm of the connecting contact protrudes downward to form a securing projection for securing the cable together with the connecting contact and the clipping contact.

5. The electrical connector as claimed in claim 1, wherein the top of the insulating housing define an accommodating cavity of which two opposite sides are provided with a pair of pivot holes facing each other at front thereof, two opposite sides of a front of the operating board oppositely protrude sideward to form a pair of pivot posts inserted in the pivot holes to pivot the operating element in the accommodating cavity.

6. The electrical connector as claimed in claim 5, wherein the two opposite sides of the accommodating cavity further define a pair of locking bumps facing each other at rear thereof, two opposite sides of a rear of the operating board define a pair of locking grooves for buckling the locking bumps therein when the operating element is closed in the accommodating cavity.

7. The electrical connector as claimed in claim 1, wherein the insulating housing includes an upper housing of which a bottom defines a receiving cavity, and a lower housing of which a top defines a receiving fillister and a receiving groove arranged behind the receiving fillister, the upper housing is coupled onto the lower housing to restrain the elastic section of the clipping contact in the receiving groove and a rear of the receiving cavity, the contact section penetrates upward through a substantial middle of the receiving cavity to resist against a bottom of the operating board, the base plate is movably received in the receiving fillister and the base strip is received in a front of the receiving cavity, the inserting trench is connected with front middles of the receiving cavity and the receiving fillister.

8. The electrical connector as claimed in claim 7, wherein the top of the lower housing further defines a fastening trench connected with a substantial middle of a rear of the receiving fillister and coaxial with the inserting trench for fastening a distal end of the cable therein.

9. The electrical connector as claimed in claim 7, wherein the bottom of the upper housing further defines a plurality of fastening holes arranged alternately at regular intervals, the top of the lower housing protrudes upward to form a plurality of fastening pillars arranged alternately at regular intervals to be inserted in the fastening holes respectively.
